(19) United States
(12) Patent Application Publication
(10) Pub. No.: US 2004/0239063 A1
(43) Pub. Date: Dec. 2, 2004

(54) Light skateboard-type leisure vehicle

(76) Inventor: Jean Dermigny, Menton (FR)

Correspondence Address: BACHMAN & LAPOINTE, P.C., 900 CHAPEL STREET, SUITE 1201, NEW HAVEN, CT, 06510, US

(21) Appl. No.: 10/482,005

(22) PCT Filed: Jun. 26, 2002
(86) PCT No.: PCT/FR02/02217

(30) Foreign Application Priority Data
Jun. 26, 2001 (FR) 01/08379

(51) Int. Cl. B62M 1/00

(52) U.S. Cl. 280/87.01

(57) ABSTRACT

A light vehicle used for leisure purposes, characterized in that the chassis thereof, when seen from the top, has a general form of an isosceles triangle, whereby two rolling members or sliding members of the rear area thereof are disposed on the opposite rear summits of the base of the triangle at equal angles and the steering axis is disposed substantially at the third summit or front summit of the triangle, footrests being disposed in the spaces provided between the constricted front part of the chassis and the rolling members and/or sliding members of the front part.

### BACKGROUND OF THE INVENTION

This invention relates to a light leisure vehicle of the type usually called “skateboard”.

The invention particularly relates to a light vehicle or machine of the type comprising:

an elongated body or chassis in the general shape of a skateboard, with an approximately horizontal surface and in which the rear part of the top face is used as a seat for its user;

two transversely opposite rear devices for rolling on the ground such as, for example, wheels or rollers (or sliding devices such as skis, runners or blades) defining a fixed rear end for which the track width is approximately equal to the transverse width of the end segment of the rear part of the chassis;

two transversely opposite front devices for rolling or sliding on the ground defining a front end;

and means of controlling the simultaneous change in the direction of the rolling or sliding devices on the front end or the rear end, about a generally vertical steering axis on the median longitudinal axis of the chassis.

This type of skateboard must have numerous qualities if it is to be satisfactory as a fun and/or sports object and very attractive for its adult or child user, and in particular it must have excellent stability due to a very low centre of gravity of the “skateboard-user” combination, which is achieved as a result of the low seated position of the user.

Thus, several skateboard designs of the general type mentioned above have already been proposed (U.S. Pat. No. 5,927,732; WO-99/48750).

Machines with rollers described in these documents have the disadvantages that they oblige the user to occupy an uncomfortable driving position which reduces the stability and steering control of the said machines, that large turning angles are not possible, and that there is a risk of the user's feet or legs being burned by friction in contact with the front wheels.

### SUMMARY OF THE INVENTION

In order to overcome these disadvantages, the invention proposes a lightweight leisure vehicle of the type described in the preamble, characterised in that the chassis as seen from above is in the general shape of an isosceles triangle, with the two rolling or sliding devices forming the rear end being located at the opposite rear vertices of the base of the isosceles triangle, and with the steering axis placed approximately at the third vertex or the front vertex of the triangle, such that the footrests are located in the spaces formed between the constricted front part of the chassis and the rolling and/or sliding devices at the front end.

In particular, the above-mentioned arrangement provides a means of optimising the weight, structural strength and dimensions of the light leisure vehicle or machine according to the invention. Moreover, this arrangement increases the dynamic stability of the machine, its manoeuvring precision and its comfort for the user to the extent that the footrests are placed in a position corresponding to a natural and effortless position for the user's legs, like the position adopted by the driver of a “kart” type vehicle.

Apart from the advantages mentioned above, the combination of characteristics including the special and innovative shape of the vehicle chassis, enables the user to find a natural driving position improving the stability and steering control of the machine, authorises large turning angles and releases a large amount of space for the feet, and eliminates the risks of burns caused by friction between the driver's legs and the front wheels.

According to another characteristic of the invention, each footrest is installed so that it is free to pivot on the front axle bar or the steering bar, and is preferably removable.

According to some attractive embodiments, each footrest is composed of a toe-clip comprising a surface on which the foot presses, and two side stops limiting sliding of the foot sideways from the said surface, and means are provided to limit the pivoting amplitude of the footrests in each direction.

As a result of these arrangements, the driver does not need to perform any contortions to control the vehicle and can control the machine while remaining in a stable and comfortable position, and can obtain remarkable driving performances.

According to another characteristic of the invention, the front axle bar comprises a vertical articulation pivot that fits into a complementary recess passing through to the lower face of the chassis, and is free to pivot and is removable, particularly using a quick fastener type design. The skateboard can thus easily be removed for transport to a place of use, while facilitating assembly and disassembly operations, since the skateboard only consists of two component sub-assemblies when it is disassembled.

According to another characteristic of the invention, adjustable pivot tightening means are provided so as to obtain controlled braking of pivoting of the front axle bar about the steering axis in order to adapt the performances of the skateboard to conditions of use and/or the skill of the user.

According to another characteristic of the invention, the front track width is wider than the rear track width, thus improving the dynamic stability of the machine, its manoeuvring precision and comfort for the user as mentioned above.

According to another characteristic of the invention, the chassis comprises two transversely opposite handles that are arranged longitudinally at the front of the rear seat area that form gripping devices for the user so that the vehicle can be used more safely with better driving comfort, particularly allowing it to resist the effects of centrifugal forces in turns without making use of a genuine seat, as is the case for a kart.

According to another characteristic of the invention, the handles are hollow handles and extend inside the chassis to protect the user's hands and/or to access devices for controlling the vehicle's braking means that are preferably arranged and designed generally in a known manner to act on the rolling devices of the fixed rear end or in order to act directly on the ground on which the machine is travelling.

According to another characteristic of the invention, and in order to further improve safety of the machine, the machine is provided with means of limiting the angle by which the front axle bar is free to pivot around the steering axis, in both directions around a central position of the axle bar corresponding to displacement in a straight line.

### BRIEF DESCRIPTION OF THE DRAWINGS

Other characteristics and advantages of the invention will become clear after reading the following detailed description, which can be more easily understood if it is read with the attached drawings in which:

FIG. 1 shows a perspective view of an exemplary embodiment of a skateboard made according to the information given in the invention and that is illustrated with the front axle bar in the assembled position on the chassis ready for use;

FIG. 2 shows a front view of the single front axle bar when it is separated from the chassis;

FIG. 3 shows an exploded perspective and partial sectional view of the main components used to make the removable and adjustable hinge of the front axle bar;

FIG. 4 shows an axial sectional view through a transverse vertical plane showing the components in FIG. 3 when the front axle bar is in the assembled or installed position on the chassis;

FIG. 5 shows a detailed diagrammatic view of the lower face of the front end of the chassis;

FIG. 6 shows a diagrammatic top view of the skateboard in FIG. 1 illustrating the user's driving position;

FIG. 7 shows a plan view with a partial tear off, in particular showing the pivoting assembly of the footrests;

FIG. 8 shows a detailed plan view of a pivoting footrest at a larger scale;

FIG. 9 shows a sectional view along line 9-9 in FIG. 8.

### DETAILED DESCRIPTION OF THE PREFERRED EMBODIMENTS

We will now describe a non-limitative exemplary application of the information and characteristics of the invention that apply to a vehicle or machine with wheels or rollers to roll on the ground, the invention also being applicable in the case in which the wheels are replaced by sliding devices such as skis or runners or blades like those used on ice skates or a bobsleigh.

This example describes a skateboard without any propulsion or traction means other than the force applied by its user and/or the earth's gravity if it is used on a more or less steeply sloping road or trail, but it would be possible to add traction devices such as a kite or a sail or similar without going outside the scope of the invention.

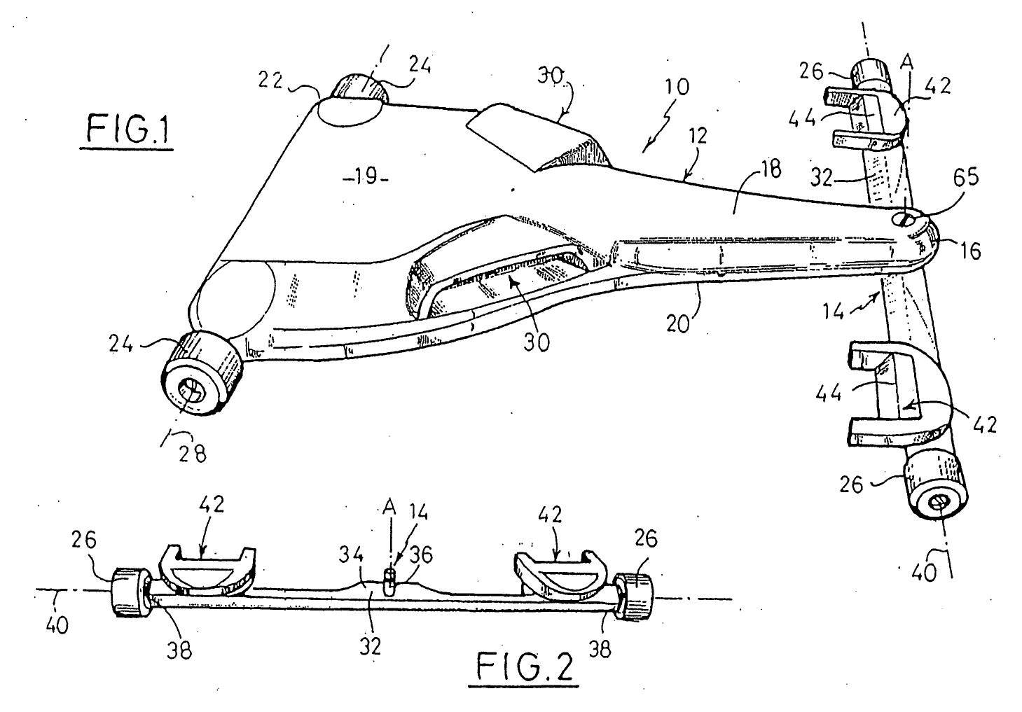

FIG. 1 shows a skateboard 10 composed essentially of a body or chassis 12 usually in the general shape of a triangular horizontal board and a front axle bar 14 installed free to pivot at the longitudinal front end 16 of the chassis 12. The front axle bar 14 forms the steering bar of the machine on which the footrests 42 described in the remainder of this presentation are located.

More precisely, in this case the chassis 12 is a hollow shell reinforced by internal elements (not shown) consisting of structural reinforcing bars making it very stiff.

The chassis is delimited by an upper horizontal face 18 and a lower face 20, which is also generally horizontal and parallel to the ground during use.

The rear area 19 of the upper face 18 forms the seat for the user “U” shown diagrammatically in silhouette in FIG. 6. It may be coated with a slip resistant material, not shown, and/or a thin cushion creating an ergonomic profile adapted to the morphology of the user to improve the seating quality and comfort.

The shell or chassis 12 is in the shape of an isosceles triangle and, like the complete machine 10, its design is generally symmetrical about the median vertical plane “P” shown in FIG. 6.

Each of the two rear transversely opposite vertices 22 of the triangle is fitted with a rotating rear wheel 24 thus defining a fixed rear end with axis 28. Like the front wheels 26, each of these wheels is fitted with ball bearings and is free to rotate, in a known manner.

The front part of the “triangular” profile of the chassis 12 becomes more slender or is constricted starting from an intermediate area immediately in front of the seating area 19 and that comprises two transversely opposite hollow handles 30 that extend towards the centre of the chassis to protect the user's hands and/or to access devices for the control of vehicle braking means, the hollow handles 30 being shaped to surround the hands, as shown in FIG. 1.

These handles perform three functions:

maintain balance;

safety, due to their hollow and surrounding shape, protecting the driver's fingers;

contain, if applicable, a device for control of a braking system.

The third vertex or the front end 16 of the chassis carries the central part 32 of the front axle bar 14, such that it is free to pivot.

Based on the above presentation, it should be remembered that according to one important characteristic arrangement of the invention, the chassis 12 of the machine, seen from above, is in the general shape of an isosceles triangle with the two rolling devices 20 or sliding devices at the rear end located on opposite rear vertices of the base of the isosceles triangle and with the steering axis 1 placed approximately at the third vertex or the front vertex 16 of the triangle, such that the footrests 42 are located in the spaces formed between the constricted front part 16 of the chassis 12 and the rolling devices 26 and/or the sliding devices of the front end.

In this case, the front axle bar 14 is in the general shape of a flat bar with a straight transverse orientation delimited by an approximately horizontal top face 34 above which there is a metallic articulation pivot 36 with axis “A” fixed to it in its centre and central part 32, and this pivot is the steering axis of the machine, in other words the axis A about which the axle bar 14 is free to pivot in both directions.

The body of the axle bar 14 supports a rotating front wheel 26 at each of its two transversely opposite ends 38, thus defining a front end with axis 40 articulated to the chassis 12 about the axis “A”.

As can be seen particularly in FIG. 6, the front track width is wider than the rear track width, and the wheelbase is determined as a function of the average size of a specific user category, for example adult, man or woman, or child. The wheelbase is the main variable that should vary depending as a function of the user's height. Thus, a board with an adjustable wheelbase could also be designed, for example by providing several holes at different longitudinal positions in the chassis for placing the pivot axis of the axle bar that can thus be located at an adjustable distance from the fixed rear end.

For an adult, the front track width may for example be of the order of 80 cm so that according to the information provided by the invention, two transversely opposite footrests 42 can be placed on the top face 34 of the front axle bar 14, and as shown in FIGS. 1, 2 and 6 are made in a single piece and are shaped to form toe-clips and possibly be fitted with a slip-resistant surface coating on the footrest area 44, in the same way that such a surface could be provided in a known manner on the seating area 19.

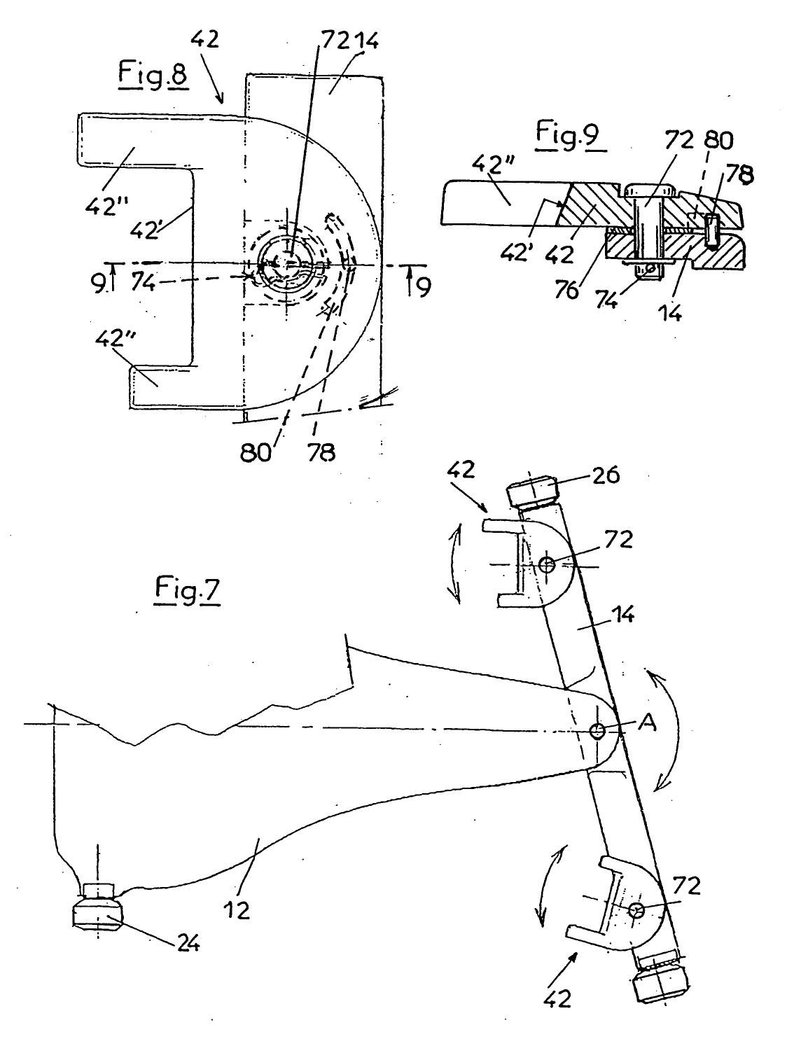

However, according to one important characteristic arrangement of the invention shown in FIGS. 7 to 9, each footrest 42 is installed free to pivot in opposite directions. For example, each footrest 42 is installed free to pivot about a fixed vertical pivot axis 72, either removably or interchangeably using a circlips, or a pin or a similar device 74 for fast and easy assembly and disassembly of the footrests. A friction-resistant washer 76 may be inserted between the footrests and the steering bar 14.

A means is provided for limiting the pivot amplitude of the footrests 42. This means may be composed of a stud 78 fixed to the steering bar and housed in a groove in the shape of an arc of a circle 80 formed in the lower face of the footrest.

Apart from the advantages mentioned above, this system enabling orientation and removal of the footrests 42 also enables the footrests to be replaced by handles specially designed so that the driver can use the machine lying flat on his belly on the chassis.

According to one very advantageous embodiment of the invention, the footrests 42 are composed of toe-clips comprising an area 42′ on which the foot presses, this surface being delimited by two side stops 42″ (FIG. 8) to prevent the foot from sliding to the right or the left side, such that the foot is forced to remain in contact with the said surface while the vehicle is in use.

As can be seen diagrammatically in FIG. 6, the free front end 16 of the chassis 12 is provided with a cylindrical housing 46 complementary to the pivot 36 that fits into it free to rotate and that projects from the lower face 20 of the chassis 12.

The machine comprises means of limiting the pivoting angle of the front axle bar 14 about the steering axis 1, in both directions, around the central position of the said axle bar corresponding to straight forwards motion.

For example, the lower face 20 comprises a stop 48 formed in relief that delimits two stop faces 50 forming a “V” that cooperate with the corresponding rear edge 52 of the body of the bar 14 to define the two maximum angular turning positions of the axle bar with respect to the chassis 12.

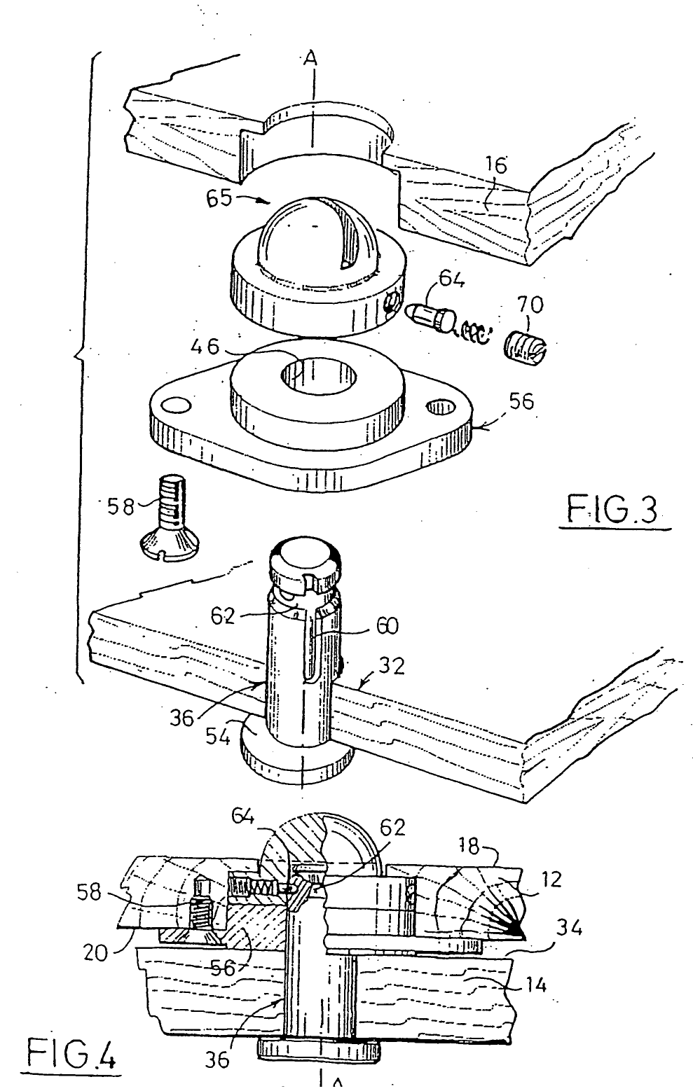

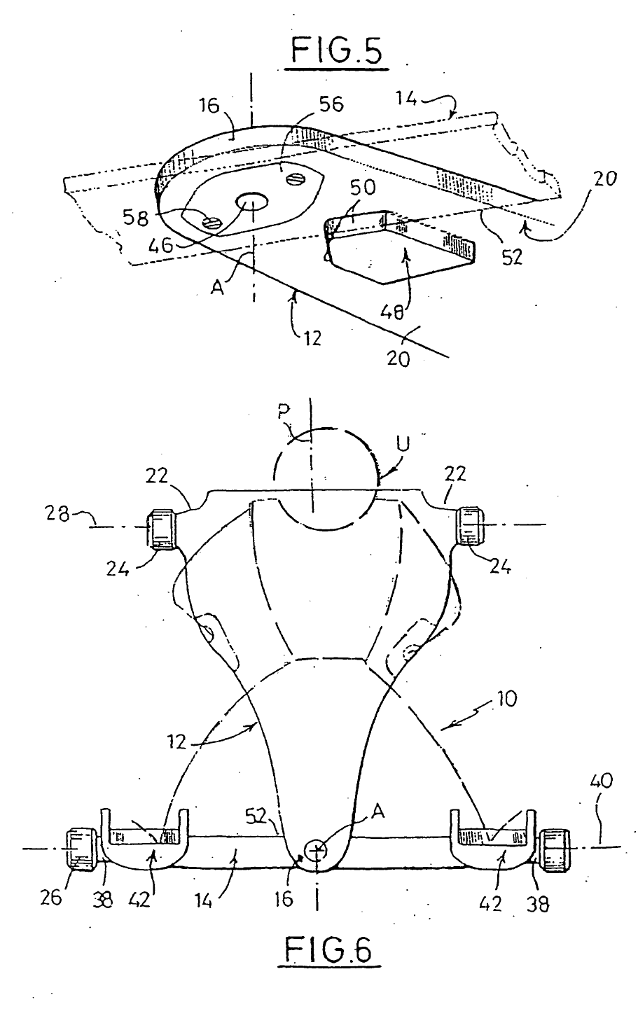

As can be seen in FIGS. 3 and 4, the pivot 36 comprises a base 54 and its cylindrical body passes vertically through the thickness of the bar 14 so that it fits into the housing 46 that is formed in a part 56 added onto the front end of the chassis 12 and fixed by screws 58.

According to one variant, the pivot may be insert moulded, depending on the materials used.

The top segment of the pivot 36 comprises a vertical groove 60 and an upper radial groove 62 into which a radial pin 64 can fit that is free to slide in a control button 65 accessible from the top face 20 of the front end 16 of the chassis 12.

The pin 64, held in place elastically by a spring and a screw 70, fits into the groove 62.

The pin 64 in the groove 62 enables fast and reliable installation of the pivot 36 in the housing 46 and rotation of the button 65 around a quarter turn to enable disassembly by bringing the vertical groove 60 to face the pin 64.

Depending on how the machine is used, means (not shown) could be added to adjust the tightness or clamping of rotation of the articulation pivot of the axle bar about its axis “A”, particularly as a function of the type of driving or control, for sports use or speed use.

The light vehicle according to the invention can be fully disassembled.

Moreover, note that the wheels or rollers can be replaced by skis, ice skates, etc.

The axle bar can be disassembled to provide a compact assembly that can be placed in a carry and protective bag, in the same way as a surfboard, with handles or straps to facilitate transport.

1-14. (cancelled)

15. A light leisure vehicle comprising:
an elongated chassis in the general shape of a skateboard with an approximately horizontal surface, in which a rear part of a top face is used as a seat for a user;
two transversely opposite rear devices for rolling or sliding on the ground defining a fixed rear end for which a track width is approximately equal to a transverse width of an end segment of the rear part of the chassis;
two transversely opposite front devices for rolling or sliding on the ground defining a front end, the front devices being installed at opposite ends of an axle bar that is mounted free to pivot at a longitudinal front end of the chassis about an approximately vertical steering axis on a median axis of the chassis, a central part of the axle bar extending below a lower face of a longitudinal front end part of the chassis on which the central part is installed free to pivot;
means for controlling the simultaneous change in the direction of the front end rolling or sliding devices, about the said steering axis, said controlling means consisting of two central devices fitted on the axle bar, close to its opposite ends, to enable the user to control steering with the user's feet;
the chassis as seen from above being in the general shape of an isosceles triangle, with said two rear rolling or sliding devices being located at opposite rear vertices of a base of the isosceles triangle, and with the steering axis placed approximately at a third vertex of the isosceles triangle, such that the central devices are located in spaces formed between a constricted front part of the chassis and the front devices at the front end.

16. A light vehicle according to claim 15, further having a front track width wider than the rear track width.

17. A light vehicle according to claim 15, wherein said central devices comprise two footrests.

18. A light vehicle according to claim 17, wherein the footrests are installed so that said footrests are free to pivot on the front axle bar of the vehicle.

19. A light vehicle according to claim 18, further including means limiting a pivoting amplitude of the footrests.

20. A light vehicle according to claim 17, wherein the footrests consist of toe-clips comprising an area on which the user's feet press, said area being delimited by two side stops such that the feet are forced to remain in contact with the said area while the vehicle is in use.

21. A light vehicle according to claim 17, wherein the footrests are installed removably on the front axle bar.

22. A light vehicle according to claim 15, wherein said central devices comprise handles installed on the front axle bar.

23. A light vehicle according to claim 15, wherein the front axle bar comprises a vertical articulation pivot that fits into a complementary recess passing through to the lower face of the chassis, and is free to pivot and is removable.

24. A light vehicle according to claim 13, further comprising articulation pivot tightening means for obtaining controlled braking or pivoting of the front axle bar about the steering axis.

25. A light vehicle according to claim 15, further comprising the chassis having two transversely opposite handles arranged longitudinally at a front of the rear seat area, said handles forming gripping devices for the user so that the vehicle can be used.

26. A light vehicle according to claim 25, wherein the handles are hollow handles with a surrounding shape that extends inside the chassis to protect the user's hands and/or to access devices for controlling vehicle braking means.

27. A light vehicle according to claim 15, further comprising means for limiting an angle by which the front axle bar is free to pivot around the steering axis in both directions around a central position of the front axle bar corresponding to displacement in a straight line.

28. A light vehicle according to claim 27, wherein the limiting means consists of a stop fixed under the front part of the chassis and comprising two stop faces forming a “V”, said stop faces cooperating with a rear edge of the said bar to define two maximum angular turning positions of the axle bar with respect to the longitudinal axis of the chassis.

29. A light vehicle according to claim 15, wherein said vehicle can be fully disassembled.
